(19) United States
(12) Patent Application Publication
(10) Pub. No.: US 2022/0155948 A1
(43) Pub. Date: May 19, 2022

(54) OFFSET TOUCH SCREEN EDITING

(71) Applicant: Adobe Inc., San Jose, CA (US)

(72) Inventors: Prachi Ramchandra CHAUDHARI, San Francisco, CA (US); Rick SEELER, San Jose, CA (US); Ming-En CHO, San Francisco, CA (US)

(21) Appl. No.: 17/097,920

(22) Filed: Nov. 13, 2020

(51) Int. Cl. G06F 3/0488; G06F 3/0482; G06F 3/0484; G06F 3/0481

(52) U.S. Cl. CPC G06F 3/04883; G06F 3/04812; G06F 3/04845; G06F 3/0482

(57) ABSTRACT

Embodiments are disclosed for perform offset editing in a digital design system. In particular, in one or more embodiments, the disclosed systems and methods comprise receiving a first input on a graphical user interface, the first input enabling an offset editing mode, displaying an offset editing tool at a first location on the graphical user interface, receiving a second input at a second location on the graphical user interface, and performing an action associated with the offset editing tool at the first location based on the second input at the second location, the second location offset from the first location.

### BACKGROUND

Computing devices (e.g., computers, tablets, smart phones) provide numerous ways for users to capture, create, share, view, and otherwise interact with numerous types of digital content (e.g., digital images). For example, touch screen are frequently included as part of a variety of computing devices such as: laptops, tablets, personal digital assistants, media players, mobile phones, and even large format interactive displays. Computing devices with touch screens allow users to interact with digital content, for example, using a graphical user interface present on the touch screen. Additionally, many computing devices facilitate interaction with digital content via one or more applications.

Some existing solutions display a loupe view (e.g., magnified area) on a region of the touch screen separate from the finger's point of contact on the touch screen. For example, in a corner of the screen or adjacent to the point of contact. However, these solutions can often be unwieldy for users, as it requires the user to pay attention to two locations on the touch screen (i.e., the loupe view and the finger's point of contact). Further, on smaller devices, by taking up a portion of the user interface, the loupe view reduces the amount of visible screen space.

These and other problems exist with regard to image editing on touch screen devices.

### SUMMARY

Introduced here are techniques/technologies for performing digital image editing based on touch gestures that allows for both precise editing without obscuring the location of editing with a finger used to perform the touch gestures. The digital design system can receive information regarding touch gestures performed at one location on a touch screen, where the touch gestures cause an editing operation to be performed at a different location on the touch screen. By having the location of editing offset from the location of the touch gestures, embodiments of the present disclosure provide benefits and/or solve one or more of the foregoing or other problems in the existing systems.

In particular, in one or more embodiments, the disclosed systems and methods may include receiving a first input on a graphical user interface. In response to the first input, an offset editing mode can be enabled, and an offset editing tool can be displayed at a first location on the graphical user interface. The disclosed systems and methods may further include receiving a second input at a second location on the graphical user interface, where the second location is offset from the first location. Based on the second input at the second location, an action associated with the offset editing tool can be performed at the first location.

In some embodiments, receiving the first input on the graphical user interface including detecting a touch gesture indicating selection of a display element on the graphical user interface.

In some embodiments, performing the action associated with the offset editing tool at the first location based on the second input at the second location includes detecting the second input starting at the second location and terminating at a third location, and performing the action associated with the offset editing tool starting at the first location and terminating at a fourth location, where the fourth location offset from the third location. In some embodiments, detecting the second input starting at the second location and terminating at the third location includes determining a distance and an angle between the first location corresponding to the offset editing tool and the second location, where the determined distance and angle indicates the offset between the first location and the second location. In some embodiments, detecting the second input starting at the second location and terminating at the third location further includes determining a direction of the long press and drag touch gesture between the second location and the third location, and maintaining the distance and the angle between the offset editing tool and third input.

In some embodiments, disclosed systems and methods may further include receiving a third input at a third location on the graphical user interface starting at the third location and terminating at a fourth location and positioning the offset editing tool at a fifth location on the graphical user interface in response to the third input.

In some embodiments, disclosed systems and methods may further include modifying a display of the offset editing tool to indicate an active state of the offset editing tool in response to the second input.

In some embodiments, disclosed systems and methods may further include receiving an action type selection and modifying a display of a cursor shape for a cursor at a center of the offset editing tool based on the action type selection. In some embodiments, the action type selection includes a draw tool, an erase tool, and a selection tool

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of performing offset editing in a digital design system in accordance with one or more embodiments;

FIG. 2 illustrates a display provided on a touch screen in accordance with one or more embodiments;

FIG. 3 illustrates a selection of an offset editing mode on the touch screen of FIG. 2 in accordance with one or more embodiments;

FIG. 4 illustrates a touch gesture performed on the touch screen of FIG. 2 for positioning an interactive offset editing tool in accordance with one or more embodiments;

FIG. 5 illustrates a touch gesture performed on the touch screen of FIG. 2 for positioning an interactive offset editing tool in accordance with one or more embodiments;

FIG. 6 illustrates a touch gesture performed on the touch screen of FIG. 2 to activate offset editing in accordance with one or more embodiments;

FIG. 7 illustrates a touch gesture performed on the touch screen of FIG. 2 in accordance with one or more embodiments;

FIG. 8 illustrates a schematic diagram of a digital design system in accordance with one or more embodiments;

FIG. 9 illustrates a flowchart of a series of acts in a method of performing offset editing in a digital design system in accordance with one or more embodiments;

FIG. 10 illustrates a schematic diagram of an exemplary environment in which the digital design system can operate in accordance with one or more embodiments; and

FIG. 11 illustrates a block diagram of an exemplary computing device in accordance with one or more embodiments.

### DETAILED DESCRIPTION

One or more embodiments of the present disclosure include a digital design system that receives touch gesture information to perform actions on a digital image (e.g., drawing, erasing, making selections, etc.), where the actions are performed at a target location offset from the location of the touch gestures. While many systems can allow users to edit digital images using touch gestures on a touch screen, they have their disadvantages. For example, because some traditional techniques perform editing operations on images at a location underneath a finger (e.g., where the finger contacts the graphical user interface), it can be exceedingly difficult to achieve precision without the ability to see where the editing is occurring. Other traditional techniques superimpose a representation of the area under the finger in a different location on the graphical user interface, such as in a loupe view that provides a magnified visualization of the area underneath the finger. However, this requires the user to focus on two locations on the touch screen: the loupe view and the location of the finger, which can be distracting. Further, the addition of a loupe view can obscure a portion of the touch screen, which can cause issues for computing device that have small touch screens.

To address these issues, the digital design system allows a user to enter an offset editing mode, e.g., by selecting one or more menu options on a graphical user interface, that causes the digital design system to display an interactive offset editing tool for a selected type. Once in the offset editing mode, the user can perform a press and drag touch gesture to position the interactive offset editing tool at a desired location on the graphical user interface. In some embodiments, the user can perform the press and drag touch gesture at any location on the GUI. When the user has positioned the interactive offset editing tool at the desired location, the user can perform a long press touch gesture that activates the interactive offset editing tool and perform a drag tough gesture while maintaining the long press touch gesture to perform an action corresponding to the selected interactive offset editing tool.

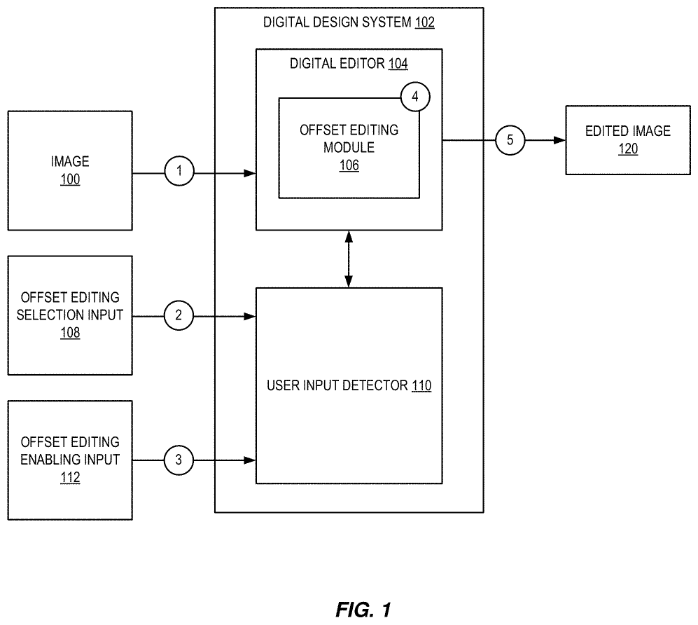

FIG. 1 illustrates a diagram of a process of performing offset editing in a digital design system in accordance with one or more embodiments. As shown in FIG. 1, in one or more embodiments, a digital design system 102 receives an image 100, as shown at numeral 1. For example, the digital design system 102 receives the image 100 from a user via a computing device. In one example, a user may select an image in a document processing application or an image processing application. In another example, a user may submit an image to a web service or an application configured to receive images as inputs. The image 100 may be any type of digital visual media. In one or more embodiments, the digital design system 102 includes a digital editor 104 that receives the image 100.

In one or more embodiments, the digital design system 102 receives an offset editing selection input 108, as shown at numeral 2. In one or more embodiments, the digital design system 102 includes a user input detector 110 that receives the offset editing selection input 108. The user input detector 110 detects, receives, and/or facilitates user input in any suitable manner. In some examples, the user input detector 110 detects one or more user interactions. As referred to herein, a “user interaction” means a single input, or combination of inputs, received from a user by way of one or more input devices, or via one or more touch gestures. A user interaction can have variable duration and may take place relative to a display provided on a touch screen.

For example, the user input detector 110 can detect a touch gesture performed on a touch screen. As used herein the term “touch gesture” refers to one or more motions or actions performed relative to a touch screen. For example, a touch gesture can comprise one or more fingers touching, sliding along, or otherwise interacting with a touch screen. In alternative embodiments, a touch gesture can comprise another object, such as a stylus, touching or otherwise interacting with a touch screen. Example touch gestures include a tap, a double-tap, a press-and-hold (or long press), a scroll, a pan, a flick, a swipe, a multi-finger tap, a multi-finger scroll, a pinch close, a pinch open, and a rotate. Although specific touch gestures are discussed in some embodiments described herein, these gestures are only examples, and other embodiments can use different touch gestures to perform the same operations in the digital design system. Users can perform touch gestures with a single hand or multiple hands. For example, a user may use two or more fingers of both hands to perform a touch gesture. Alternative embodiments may include other more complex touch gestures that include multiple fingers of both hands.

In particular, the user input detector 110 can detect one or more touch gestures provided by a user by way of the touch screen. In some examples, the user input detector 110 can detect touch gestures in relation to and/or directed at one or more display elements displayed as part of a display presented on the touch screen.

The user input detector 110 may additionally, or alternatively, receive data representative of a user interaction. For example, the user input detector 110 may receive one or more user configurable parameters from a user, one or more commands from the user, and/or any other suitable user input. In particular, the user input detector 110 can receive voice commands or otherwise sense, detect, or receive user input.

In one or more embodiment, the offset editing selection input 108 is a selection of a display element (e.g., a menu item or icon), via a short press, that causes the digital design system 102 to perform or initiate an action. For example, the digital editor 104 can utilize the offset editing selection input 108 detected by the user input detector 110 to cause an offset editing module 106 to initiate the display of an interactive offset editing tool on the display provided on the touch screen. Examples of interactive offset editing tools can include an erase tool, drawing tools, and a lasso selection tool.

In one or more embodiments, the offset editing selection input 108 is also a touch gesture on the display that the offset editing module 106 can utilize to move the interactive offset editing tool on the display provided on the touch screen to a position specified by the offset editing selection input 108. For example, when the offset editing selection input 108 is a short press and drag touch gesture, the offset editing module 106 can move the interactive offset editing tool on the display based on the direction and distance of the drag touch gesture.

As shown at numeral 3, the digital design system 102 receives an offset editing enabling input 112. Similar to as described above, in one or more embodiments, the user input detector 110 receives the offset editing enabling input 112. The offset editing enabling input 112 can be a touch gesture (e.g., a long press) on the touch screen. In such embodiments, a long press touch gesture causes the activation of the editing tool selected in numeral 2.

After the activation of the editing tool caused by the offset editing enabling input 112, the offset editing module 106 can also be used to perform or initiate an action, as shown at numeral 4. In some examples, the user input detector 110 detects one or more user interactions in the offset editing enabling input 112. For example, the offset editing enabling input 112 can also be a touch gesture on the display that the offset editing module 106 can utilize to perform an editing action on the image.

At numeral 5, the digital design system 102 can return the edited image 120 to the user. After the process described above in numerals 1-4, the edited image 120 is sent to the user or computing device that initiated the editing process with the digital design system 102.

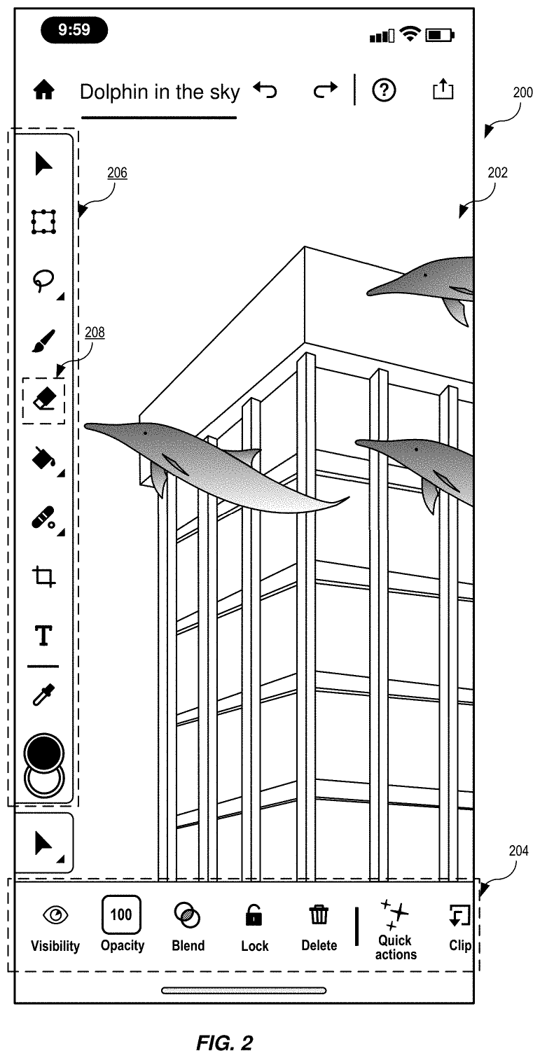

FIG. 2 illustrates a display provided on a touch screen in accordance with one or more embodiments. FIG. 2 illustrates a touch screen display (e.g., of a client device) displaying a graphical user interface 200 of a digital design system. In one or more embodiments, the touch screen can display a graphical user interface of any one of a variety of programs. For example, in FIG. 2-7, the graphical user interface is a graphical user interface of a digital design system configured to receive user inputs and perform edits to digital images in response to the user inputs.

As illustrated in FIG. 2, the graphical user interface 200 includes one or more display elements such as text, digital images, buttons, hyperlinks, multimedia displays, interactive fields or boxes, or any other collection or combination of items suitable for inclusion on a graphical user interface. As shown, the graphical user interface 200 of FIG. 2 includes a plurality of display elements: image 202, menu buttons 204, digital editing menu buttons 206, including an erase menu button 208. As illustrated in FIG. 2, image 202 is a multi-layered digital image with a layer of dolphins overlayed on a background image of a building. In FIG. 2, the display elements 204-08 are interactive buttons or icons that the user can select (e.g., by pressing a finger against one or more of the buttons or icons) to cause the digital design system to perform an action). In alternative embodiments, the display elements may be any other type of display element as described above.

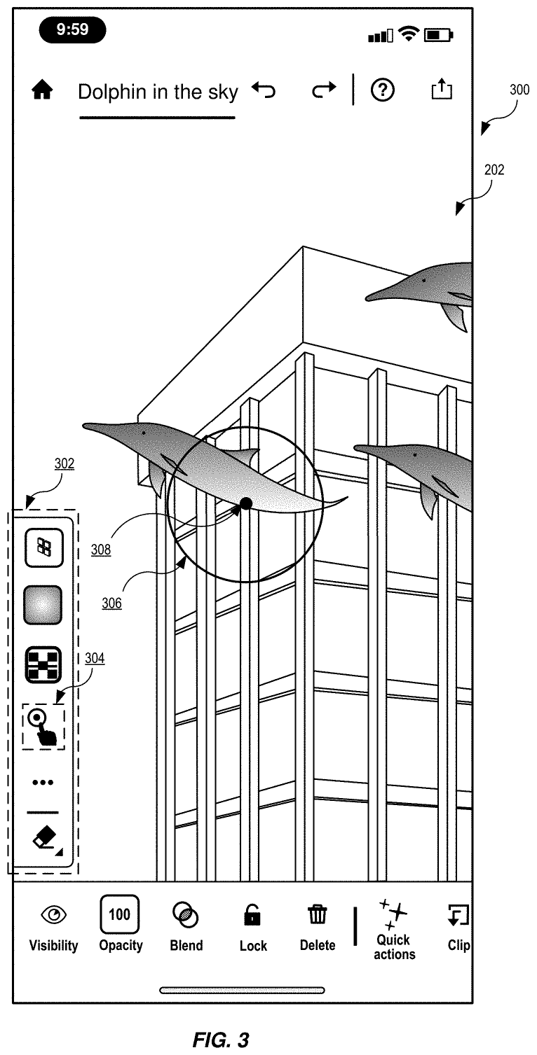

FIG. 3 illustrates a selection of an offset editing mode on the touch screen of FIG. 2 in accordance with one or more embodiments. In one or more embodiments, selection of the erase menu button 208 in the graphical user interface 200 of FIG. 2 causes the display of the graphical user interface 300 of FIG. 3. As shown, the graphical user interface 300 includes a plurality of display elements: image 202 and erase editing tools buttons 302. As illustrated in FIG. 3, the erase editing tools buttons 302 include an offset editing button 304. In one or more embodiments, in response to receiving a user interaction (e.g., touch gesture) with the offset editing button 304, the digital design system enables an offset mode. In one or more embodiments, when the offset mode is enabled, a visual representation of an interactive offset editing tool is displayed over the image 202 in the graphical user interface 300. As illustrated in FIG. 3, an interactive offset editing tool 306 is a visual indication that the offset mode has been activated, and the cursor 308 indicates a size of the selected editing function. As illustrated in FIG. 3, the interactive offset editing tool 306 is depicted as a hollow circle with the cursor 308 at its center. However, the representation of the interactive offset editing tool 306 may take alternate forms in alternate embodiments (e.g., a square or other shape). In one or more embodiments, the size of the interactive offset editing tool 306 can be larger or smaller than represented in FIG. 3. Similarly, the size of the cursor 308 can be larger or smaller, based on selection. For example, in response to a user input selecting a smaller erase tool, the cursor 308 can be decreased in size, and in response to a user input selecting a larger erase tool, the cursor 308 can be increased in size.

As illustrated in FIG. 3, the digital design system causes the cursor 308 to be visualized at the center of the graphical user interface 300. In other embodiments, the digital design system causes the cursor 308 to be visualized at another location on the graphical user interface 300 (e.g., a default location other than the center of the graphical user interface 300, a default location defined by the user, a last point of contact detected by the digital design system, a last location where an edit was performed, etc.).

In some embodiments, when the digital design system detects a period of inactivity, the digital design system modifies the visualization of the interactive offset editing tool 306. A period of activity can be detected when there is no user contact with the touch screen for a threshold amount of time (e.g., one second). In response to detecting the period of inactivity, the digital design system can remove the interactive offset editing tool 306 from being displayed on the graphical user interface 300, cause the interactive offset editing tool 306 to be semi-transparent, etc. In response to detecting user activity (e.g., contact with the touch screen), the digital design system can restore the interactive offset editing tool 306 to being full visible.

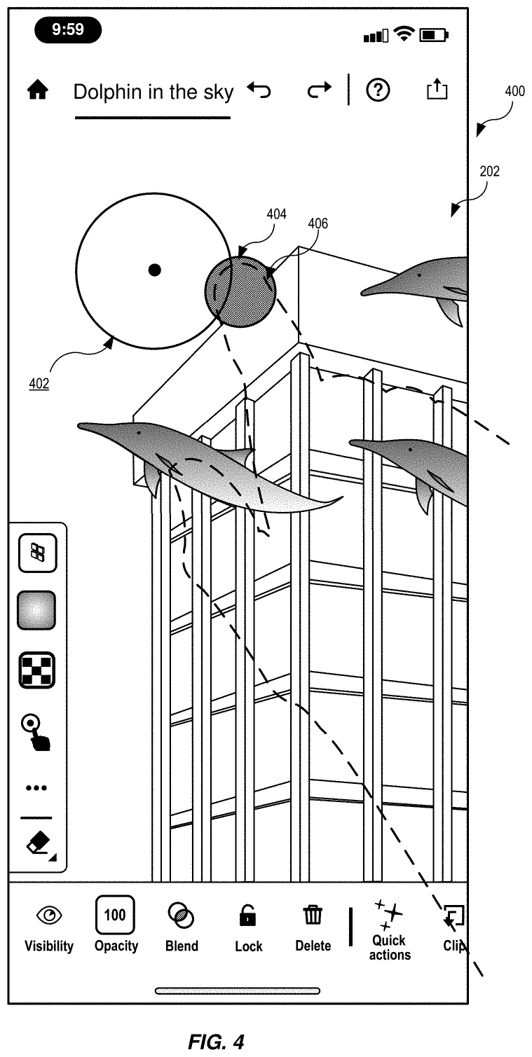

FIG. 4 illustrates a touch gesture performed on the touch screen of FIG. 2 for positioning an interactive offset editing tool in accordance with one or more embodiments. As shown, a graphical user interface 400 includes a plurality of display elements: image 202 and an interactive offset editing tool 402. FIG. 4 illustrates a visual representation of a touch gesture 404 displayed on the graphical user interface 400 in response to the digital design system detecting a touch gesture performed by a finger 406. In one or more embodiments, the touch gesture is a one-finger multi-point touch gesture. Examples of a one-finger multi-point touch gesture can include a scroll gesture, a flick gesture, pan gesture, or another similar type of gesture.

In response to receiving a touch gesture from a user, the digital design system causes the visual representation of a touch gesture 404 to appear around the point of contact by the finger 406 on the graphical user interface 400. In one or more embodiments, in response to a touch gesture, the user can move the interactive offset editing tool 402 around on the graphical user interface 400. By allowing a touch gesture to control the interactive offset editing tool 402 to occur at a location offset from the location where an editing action will occur allows for the location where the editing action will occur to not be obscured by the finger 406.

It will be understood that while the visual representation of the touch gesture 404 is illustrated as a circle displayed in connection with the visual representation of the finger 406, the visual representation of the touch gesture 404 may take alternate forms in alternate embodiments. For example, the visual representation of the touch gesture 404 can be a square or other shape, a pulsing region on the graphical user interface 400, etc. In yet other embodiments, the digital design system does not display the visual representation of the touch gesture 404. In some embodiments, the user can modify a setting indicating whether the digital design system is to display the visual representation of the touch gesture 404.

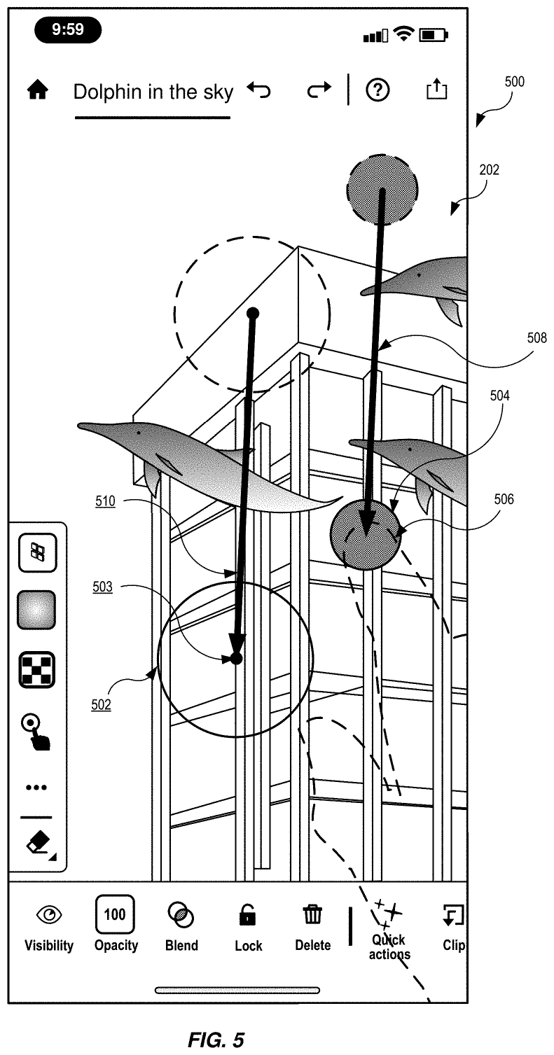

FIG. 5 illustrates a touch gesture performed on the touch screen of FIG. 2 for positioning an interactive offset editing tool in accordance with one or more embodiments. As shown, a graphical user interface 500 includes a plurality of display elements: image 202 and an interactive offset editing tool 502. FIG. 5 illustrates a visual representation of a touch gesture 504 displayed on the graphical user interface 500 in response to the digital design system detecting a touch gesture performed by a finger 506. FIG. 5 illustrates that the touch gesture for moving the interactive offset editing tool 502 can be performed at different locations on the graphical user interface 500 and at different orientations relative to the interactive offset editing tool 502, as compared to the example illustrated in FIG. 4.

In one or more embodiments, when a short press and drag touch gesture is received, the user can move the interactive offset editing tool 502 on the graphical user interface. For example, as illustrated in FIG. 5, the digital design system detects that the user has performed a short press and drag touch gesture on the graphical user interface 500 (as denoted by the touch gesture path 508), which causes the digital design system to move the interactive offset editing tool 502 from a first location on the graphical user interface 500 to a second location on the graphical user interface 500, as denoted by the path 510. In one or more embodiments, when the short press and drag touch gesture is detected, the digital design system determines the location on the touch screen where the short press and drag touch gesture was initiated and determines a distance and angle from a cursor 503 at the center of the interactive offset editing tool 502. In such embodiments, as the user performs the short press and drag touch gesture on the touch screen, the digital design system maintains the same distance and angle between the finger performing the touch gesture and the interactive offset editing tool 502.

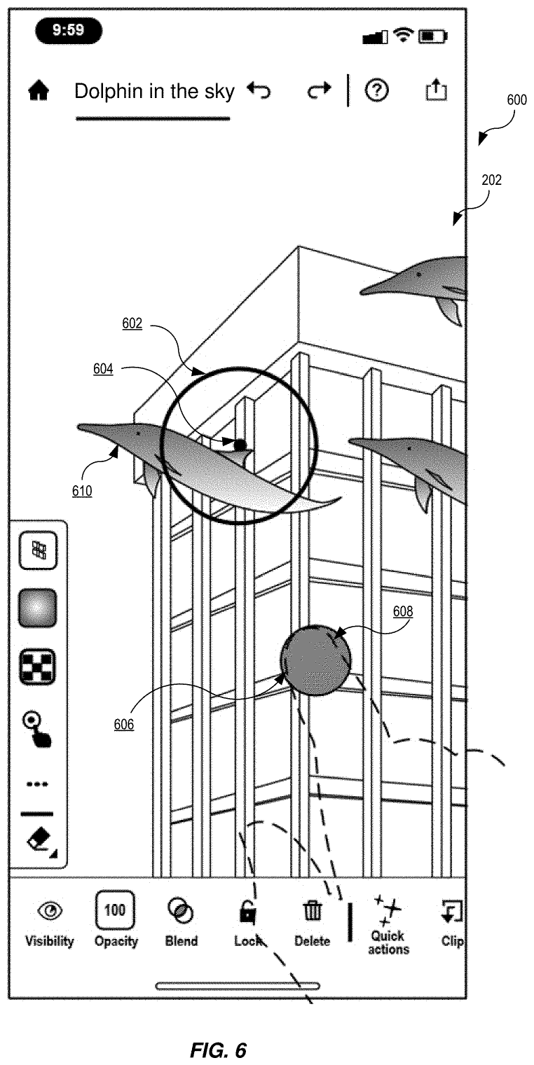

FIG. 6 illustrates a touch gesture performed on the touch screen of FIG. 2 to activate offset editing in accordance with one or more embodiments. As shown, a graphical user interface 600 includes a plurality of display elements: image 202 and an interactive offset editing tool 602. As illustrated in FIG. 6, in response to user touch gestures, the interactive offset editing tool 602 has been positioned at a location on the image 202 where the cursor 308 is located. For example, the cursor 604 at the center of the interactive offset editing tool 602 may have been moved to the location near the dolphin 610 using a one-finger multi-point touch gesture (e.g., a press and drag).

FIG. 6 illustrates a visual representation of a touch gesture 606 in response to a one-finger multi-point touch gesture performed by a finger 608. As illustrated in FIG. 6, the touch gesture is a long press. In one or more embodiments, when the digital design system detects a long press touch gesture, offset editing is activated or put into an active state. In one or more embodiments, the digital design system provides an indication that the offset editing is activated by modifying the interactive offset editing tool 602, e.g., by the increased width of the interactive offset editing tool 602 in FIG. 6. In other embodiments, the digital design system visualizes the indication that the interactive offset editing tool 602 is activated by causing one or both of the interactive offset editing tool 602 and a cursor 604 at the center of the interactive offset editing tool 602 to pulse or blink, or by causing the interactive offset editing tool 602 and/or the cursor 604 to change shapes and/or color. In another embodiment, the digital design system visualizes the indication that the interactive offset editing tool 602 is activated by causing the interactive offset editing tool 602 to be hidden from display on the graphical user interface 600.

In one or more embodiments, after the user activates the interactive offset editing tool 602, the user can perform an editing action by dragging their finger on the graphical user interface 600. In one or more embodiments, when the long press is detected, the digital design system determines the location on the touch screen where the long press and drag touch gesture was initiated and determines a distance and angle from the cursor 604 at the center of the interactive offset editing tool 602. In such embodiments, as the user performs the long press and drag touch gesture on the touch screen, the digital design system maintains the same distance and angle between the finger performing the touch gesture (e.g., finger 608) and the interactive offset editing tool 602 regardless of where the finger is moved on the touch screen.

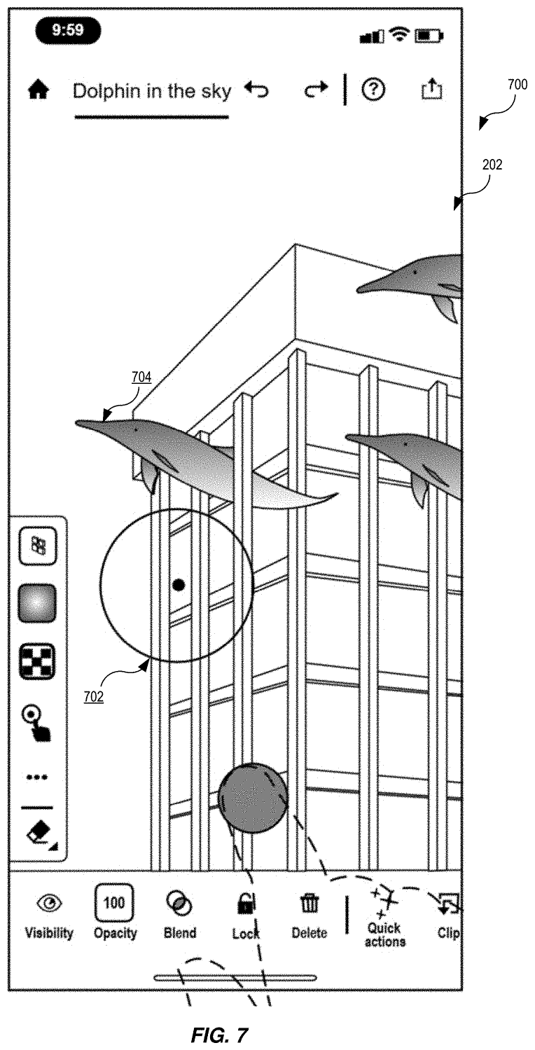

FIG. 7 illustrates a touch gesture performed on the touch screen of FIG. 2 in accordance with one or more embodiments. As shown, a graphical user interface 700 includes a plurality of display elements: image 202 and an interactive offset editing tool 702. As illustrated in FIG. 7, an erasure operation using the interactive offset editing tool 702. For example, after positioning the interactive offset editing tool 702 at the location illustrated in FIG. 6, the user has performed a one-finger multi-point touch gesture (e.g., a long press and drag). The user may have performed multiple drags to erase a portion of the dolphin 704. By using the interactive offset editing tool 702, the user can perform a more precise edit to the image 202 without their finger obscuring the location to be edited.

In one or more embodiments, after completing the edition operation, the user can release their touch gesture from the graphical user interface 700 and move the interactive offset editing tool 702 using a one-finger multi-point touch gesture (e.g., a press and drag) to place the interactive offset editing tool 702 in the location illustrated in FIG. G.

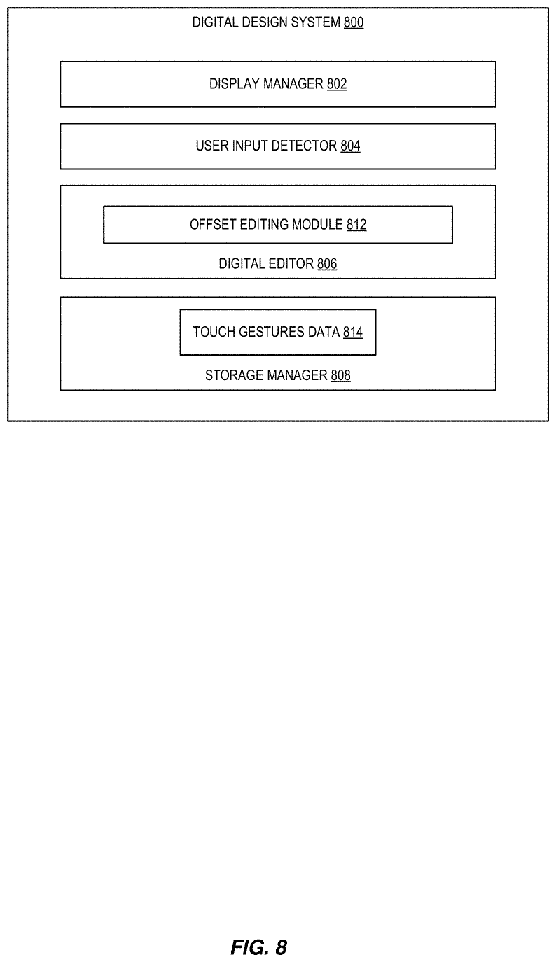

FIG. 8 illustrates a schematic diagram of a digital design system (e.g., “digital design system” described above) in accordance with one or more embodiments. As shown, the digital design system 800 may include, but is not limited to, a display manager 802, a user input detector 804, a digital editor 806, and a storage manager 808. As shown, the digital editor 806 includes an offset editing module 812. The storage manager 808 includes input data 814.

As illustrated in FIG. 8, the digital design system 800 includes a display manager 802. In one or more embodiments, the display manager 802 identifies, provides, manages, and/or controls display provided on a touch screen or other device. Examples of displays include videos, interactive whiteboards, video conference feeds, images, graphical user interfaces (or simply “user interfaces”) that allow a user to view and interact with content items, or other items capable of display on a touch screen. For example, the display manager 802 may identify, display, update, or otherwise provide various user interfaces that contain one or more display elements in various layouts. In one or more embodiments, the display manager 802 can identify a display provided on a touch screen. For example, a display provided on a touch screen may include a graphical user interface including one or more display elements capable of being interacted with via one or more touch gestures.

More specifically, the display manager 802 can identify a variety of display elements within a graphical user interface as well as the layout of the graphical user interface. For example, the display manager 802 may identify a graphical user interface provided on a touch screen including one or more display elements. Display elements include, but are not limited to: buttons, text boxes, menus, thumbnails, scroll bars, hyperlinks, etc. In one or more embodiments, the display manager 802 can identify a graphical user interface layout as well as the display elements displayed therein.

As further illustrated in FIG. 8, the digital design system 800 also includes a user input detector 804. The user input detector 804 detects, receives, and/or facilitates user input in any suitable manner. In some examples, the user input detector 804 detects one or more user interactions. As referred to herein, a “user interaction” means a single input, or combination of inputs, received from a user by way of one or more input devices, or via one or more touch gestures. A user interaction can have variable duration and may take place relative to a display provided on a touch screen.

For example, the user input detector 804 can detect a touch gesture performed on a touch screen. In particular, the user input detector 804 can detect one or more touch gestures (e.g., tap gestures, swipe gestures, pinch gestures) provided by a user by way of the touch screen. In some embodiments, the user input detector 804 can detect touch gestures based on one point of contact or multiple points of contact on the touch screen. In some examples, the user input detector 804 can detect touch gestures in relation to and/or directed at one or more display elements displayed as part of a display presented on the touch screen.

The user input detector 804 may additionally, or alternatively, receive data representative of a user interaction. For example, the user input detector 804 may receive one or more user configurable parameters from a user, one or more commands from the user, and/or any other suitable user input. In particular, the user input detector 804 can receive voice commands or otherwise sense, detect, or receive user input.

As further illustrated in FIG. 8, the digital design system 800 also includes a digital editor 806. In one or more embodiments, the digital editor 806 provide digital image-editing functions, including drawing, painting, measuring and navigation, selection, typing, and retouching. In one or more embodiments, the digital editor 806 utilizes the inputs (e.g., touch gestures) received by the user input detector 804 to cause an offset editing module 812 to initiate the display of an interactive offset editing tool on a display provided on a touch screen and/or perform editing operations on a digital image. Examples of interactive offset editing tools can include an erase tool, drawing tools, and a lasso selection tool.

In one or more embodiments, when a short press and drag touch gesture is detected, the offset editing module 812 determines the location on the touch screen where the short press and drag touch gesture was initiated and determines a distance and angle from the center of an interactive offset editing tool. In such embodiments, as the user performs the short press and drag touch gesture on the touch screen, the offset editing module 812 maintains the same distance and angle between the finger performing the touch gesture and the interactive offset editing tool 502 wherever the user moves within the graphical user interface until the user releases their finger from the touch screen.

In one or more embodiments, the offset editing module 812 also performs or initiates an action in the digital design system in response to inputs from a user. For example, in response to a long press and drag touch gesture, the offset editing module 812 can perform a selected action (e.g., draw, erase, select, etc.) on a digital image at the location(s) the cursor of the interactive offset editing tool is located as the user performs the long press and drag touch gesture and until the user releases their finger from the touch screen.

As further illustrated in FIG. 8, the storage manager 808 includes touch gestures data 814. In particular, the touch gestures data 814 may include any information associated with various user input events. In one or more embodiments, the touch gestures data 814 includes information associated with various touch gestures that the user input detector 804 and/or digital editor 806 accesses and uses to identify a touch gesture corresponding to an incoming or received series of inputs. For example, when the digital design system 800 receives one or more inputs of a series of user inputs, the user input detector 804 and/or digital editor 806 can access touch gestures data 814 and draw from a storage of various touch gestures that the user input detector 804 and/or digital editor 806 are capable of receiving and processing.

Each of the components 802-808 of the digital design system 800 and their corresponding elements (as shown in FIG. 8) may be in communication with one another using any suitable communication technologies. It will be recognized that although components 802-808 and their corresponding elements are shown to be separate in FIG. 8, any of components 802-808 and their corresponding elements may be combined into fewer components, such as into a single facility or module, divided into more components, or configured into different components as may serve a particular embodiment.

The components 802-808 and their corresponding elements can comprise software, hardware, or both. For example, the components 802-808 and their corresponding elements can comprise one or more instructions stored on a computer-readable storage medium and executable by processors of one or more computing devices. When executed by the one or more processors, the computer-executable instructions of the digital design system 800 can cause a client device and/or a server device to perform the methods described herein. Alternatively, the components 802-808 and their corresponding elements can comprise hardware, such as a special purpose processing device to perform a certain function or group of functions. Additionally, the components 802-808 and their corresponding elements can comprise a combination of computer-executable instructions and hardware.

Furthermore, the components 802-808 of the digital design system 800 may, for example, be implemented as one or more stand-alone applications, as one or more modules of an application, as one or more plug-ins, as one or more library functions or functions that may be called by other applications, and/or as a cloud-computing model. Thus, the components 802-808 of the digital design system 800 may be implemented as a stand-alone application, such as a desktop or mobile application. Furthermore, the components 802-808 of the digital design system 800 may be implemented as one or more web-based applications hosted on a remote server. Alternatively, or additionally, the components of the digital design system 800 may be implemented in a suit of mobile device applications or “apps.” To illustrate, the components of the digital design system 800 may be implemented in a document processing application or an image processing application, including but not limited to ADOBE® Acrobat, ADOBE® Photoshop, and ADOBE® Illustrator. “ADOBE®” is either a registered trademark or trademark of Adobe Inc. in the United States and/or other countries.

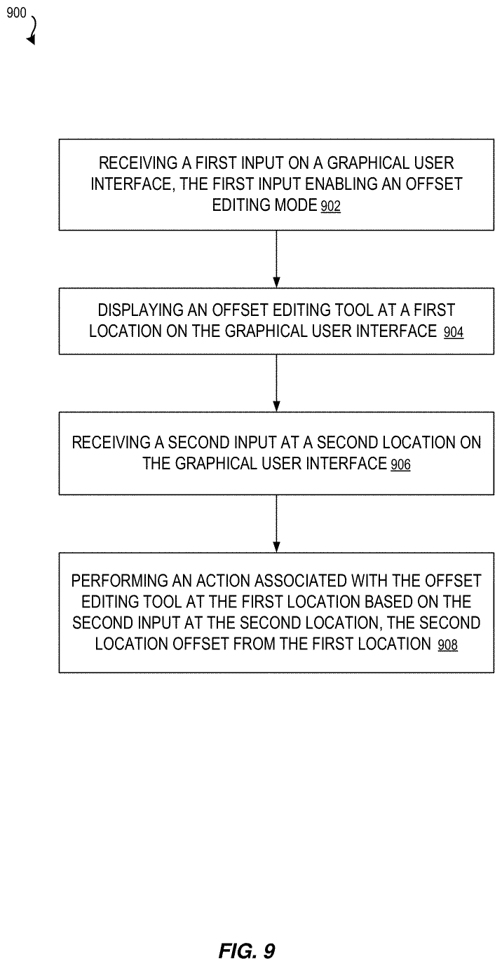

FIGS. 1-8, the corresponding text, and the examples, provide a number of different systems and devices that allows a digital design system to perform digital image editing on an image based on touch gestures on a touch screen offset from a location of editing. In addition to the foregoing, embodiments can also be described in terms of flowcharts comprising acts and steps in a method for accomplishing a particular result. For example, FIG. 9 illustrates a flowchart of an exemplary method in accordance with one or more embodiments. The method described in relation to FIG. 9 may be performed with less or more steps/acts or the steps/acts may be performed in differing orders. Additionally, the steps/acts described herein may be repeated or performed in parallel with one another or in parallel with different instances of the same or similar steps/acts.

FIG. 9 illustrates a flowchart of a series of acts in a method of performing offset editing in a digital design system in accordance with one or more embodiments. In one or more embodiments, the method 900 is performed in a digital medium environment that includes the digital design system 800. In one or more embodiments, the method 900 is performed after the digital design system 800 obtains an image. For example, the digital design system can receive the image from a user (e.g., via a computing device). A user may select an image in a document processing application or an image processing application, or the user may submit an image to a web service or an application configured to receive images as inputs.

The method 900 is intended to be illustrative of one or more methods in accordance with the present disclosure and is not intended to limit potential embodiments. Alternative embodiments can include additional, fewer, or different steps than those articulated in FIG. 9.

As shown in FIG. 9, the method 900 also includes an act 902 of receiving a first input on a graphical user interface, where the first input enables an offset editing mode. In one or more embodiments, the digital design system detects a touch gesture indicating selection of a display element on the graphical user interface. For example, the digital design system can detect a tap on the graphical user interface that interacts with a display element (e.g., a menu button or icon) the causes the digital design system to enable an offset editing mode. In one or more embodiments, the first input can indicate both the enabling of the offset editing mode and an action type. Example action types can include, but are not limited to, a draw action, an erase action, a selection action, etc.

As shown in FIG. 9, the method 900 also includes an act 904 of displaying an interactive offset editing tool at a first location on the graphical user interface. In one or more embodiments, in response to the first input on the graphical user interface, the digital design system can cause an interactive offset editing tool to be visualized or displayed on the graphical user interface. For example, the interactive offset editing tool can be visualized at the center of the graphical user interface or at another location on the graphical user interface (e.g., a default location other than the center of the graphical user interface, a default location defined by the user, a last point of contact detected by the digital design system, a last location where an edit was performed, etc.).

In one or more embodiments, the digital design system displays the interactive offset editing tool as a hollow circle with a center cursor. In other embodiments, the digital design system displays the interactive offset editing tool using a square or another shape. Further, the center cursor can be displayed using any shape or using a representation of tool related to a selected action (e.g., a brush or pencil for a drawing action, an eraser for an erase action, etc.).

As shown in FIG. 9, the method 900 also includes an act 906 of receiving a second input at a second location on the graphical user interface. In one or more embodiments, the second input is different from the first input. For example, the second input can be an input that activates offset editing (e.g., places the interactive offset editing tool into an active state). In one or more embodiments, the second input is at a location offset from the location of the interactive offset editing tool. In such embodiments, the digital design system determines or detects the distance and angle from the cursor at the center of the interactive offset editing tool. In such embodiments, as the user performs touch gestures on the graphical user interface (e.g., the second input), the digital design system maintains the same offset (e.g., the same distance and angle) between the finger performing the touch gesture and the interactive offset editing tool as the finger interacts with the graphical user interface.

In one or more embodiments, when the second input activates offset editing, the digital design system modifies the depiction of the interactive offset editing tool. For example, the digital design system can change the color, size, or shape of the interactive offset editing tool, causes the interactive offset editing tool to pulse or blink, etc.

As shown in FIG. 9, the method 900 also includes an act 908 of performing an action associated with the interactive offset editing tool at the first location based on the second input at the second location, where the second location is offset from the first location. For example, the digital design system can detect a second input starting at the second location and terminating at a third location (e.g., a long press and drag touch gesture), and correspondingly perform an action on the image starting at the first location and terminating at a fourth location. The action can be performed on the image in the same direction on the image as the second input on the graphical user interface, while maintaining the same offset distance and angle between the location of the second input and the location of the action on the image. For example, when the action is an erase action, the digital design system can erase a portion of an image starting from the first location and terminating at the fourth location.

After the second input is completed, the digital design system can place the interactive offset editing tool in an inactive state. For example, in response to the user ending a long press and drag touch gesture (e.g., by lifting their finger from the touch screen), the digital design system can modify the shape and/or color of the interactive offset editing tool or deactivate a flashing or pulsing of the interactive offset editing tool to indicate that the interactive offset editing tool is in an inactive state.

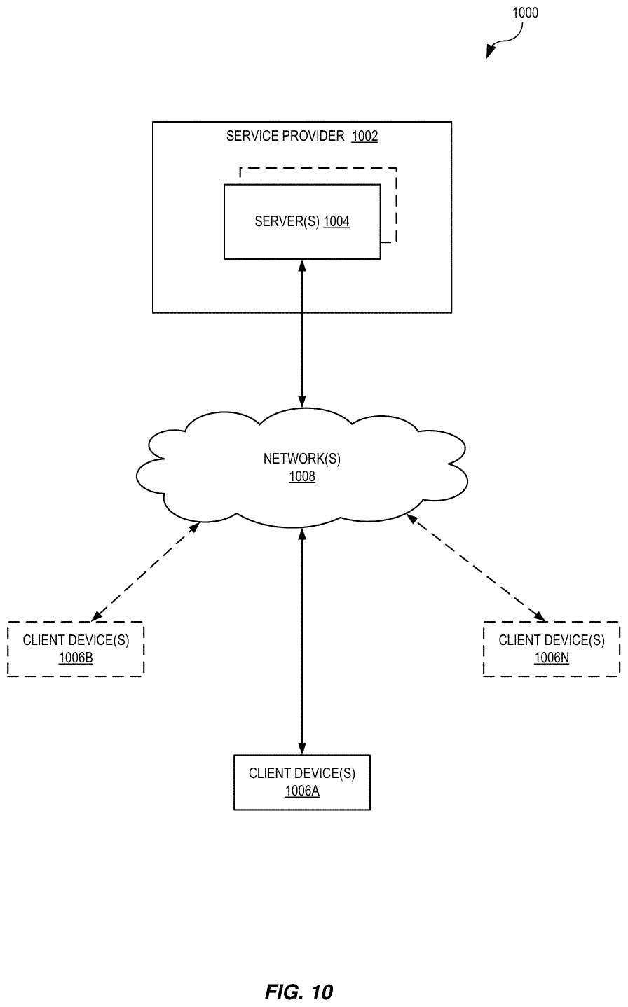

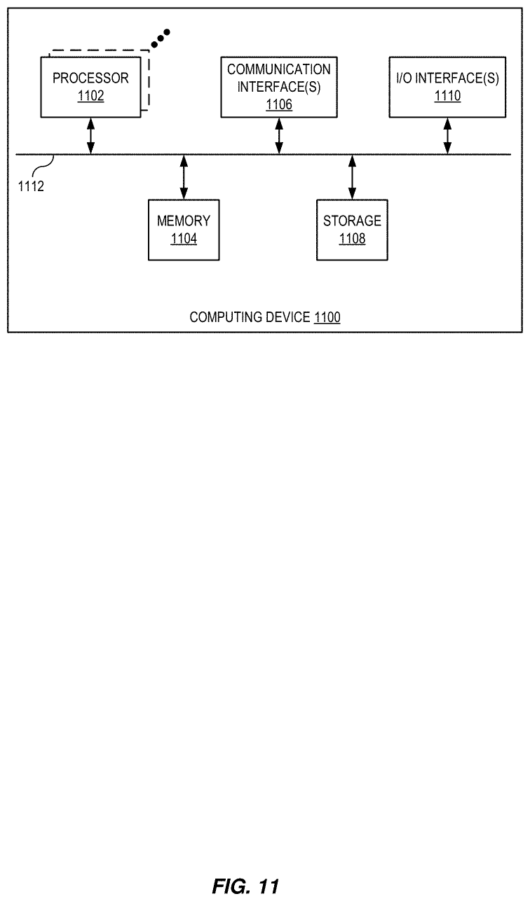

FIG. 10 illustrates a schematic diagram of an exemplary environment 1000 in which the digital design system 800 can operate in accordance with one or more embodiments. In one or more embodiments, the environment 1000 includes a service provider 1002 which may include one or more servers 1004 connected to a plurality of client devices 1006A-1006N via one or more networks 1008. The client devices 1006A-1006N, the one or more networks 1008, the service provider 1002, and the one or more servers 1004 may communicate with each other or other components using any communication platforms and technologies suitable for transporting data and/or communication signals, including any known communication technologies, devices, media, and protocols supportive of remote data communications, examples of which will be described in more detail below with respect to FIG. 11.

Although FIG. 10 illustrates a particular arrangement of the client devices 1006A-1006N, the one or more networks 1008, the service provider 1002, and the one or more servers 1004, various additional arrangements are possible. For example, the client devices 1006A-1006N may directly communicate with the one or more servers 1004, bypassing the network 1008. Or alternatively, the client devices 1006A-1006N may directly communicate with each other. The service provider 1002 may be a public cloud service provider which owns and operates their own infrastructure in one or more data centers and provides this infrastructure to customers and end users on demand to host applications on the one or more servers 1004. The servers may include one or more hardware servers (e.g., hosts), each with its own computing resources (e.g., processors, memory, disk space, networking bandwidth, etc.) which may be securely divided between multiple customers, each of which may host their own applications on the one or more servers 1004. In some embodiments, the service provider may be a private cloud provider which maintains cloud infrastructure for a single organization. The one or more servers 1004 may similarly include one or more hardware servers, each with its own computing resources, which are divided among applications hosted by the one or more servers for use by members of the organization or their customers.

Similarly, although the environment 1000 of FIG. 10 is depicted as having various components, the environment 1000 may have additional or alternative components. For example, the environment 1000 can be implemented on a single computing device with the digital design system 800. In particular, the digital design system 800 may be implemented in whole or in part on the client device 1002A.

As illustrated in FIG. 10, the environment 1000 may include client devices 1006A-1006N. The client devices 1006A-1006N may comprise any computing device. For example, client devices 1006A-1006N may comprise one or more personal computers, laptop computers, mobile devices, mobile phones, tablets, special purpose computers, TVs, or other computing devices, including computing devices described below with regard to FIG. 11. Although three client devices are shown in FIG. 10, it will be appreciated that client devices 1006A-1006N may comprise any number of client devices (greater or smaller than shown).

Moreover, as illustrated in FIG. 10, the client devices 1006A-1006N and the one or more servers 1004 may communicate via one or more networks 1008. The one or more networks 1008 may represent a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. Thus, the one or more networks 1008 may be any suitable network over which the client devices 1006A-1006N may access service provider 1002 and server 1004, or vice versa. The one or more networks 1008 will be discussed in more detail below with regard to FIG. 11.

In addition, the environment 1000 may also include one or more servers 1004. The one or more servers 1004 may generate, store, receive, and transmit any type of data, including touch gestures data 814 or other information. For example, a server 1004 may receive data from a client device, such as the client device 1006A, and send the data to another client device, such as the client device 1002B and/or 1002N. The server 1004 can also transmit electronic messages between one or more users of the environment 1000. In one example embodiment, the server 1004 is a data server. The server 1004 can also comprise a communication server or a web-hosting server. Additional details regarding the server 1004 will be discussed below with respect to FIG. 11.

As mentioned, in one or more embodiments, the one or more servers 1004 can include or implement at least a portion of the digital design system 800. In particular, the digital design system 800 can comprise an application running on the one or more servers 1004 or a portion of the digital design system 800 can be downloaded from the one or more servers 1004. For example, the digital design system 800 can include a web hosting application that allows the client devices 1006A-1006N to interact with content hosted at the one or more servers 1004. To illustrate, in one or more embodiments of the environment 1000, one or more client devices 1006A-1006N can access a webpage supported by the one or more servers 1004. In particular, the client device 1006A can run a web application (e.g., a web browser) to allow a user to access, view, and/or interact with a webpage or website hosted at the one or more servers 1004.

Upon the client device 1006A accessing a webpage or other web application hosted at the one or more servers 1004, in one or more embodiments, the one or more servers 1004 can provide a user of the client device 1006A with an interface to provide an image file or a document including an image, or an interface to select a portion of a document including an image. Upon receiving the image, the one or more servers 1004 can automatically perform the methods and processes described above to perform offset editing of the image.

As just described, the digital design system 800 may be implemented in whole, or in part, by the individual elements 1002-1008 of the environment 1000. It will be appreciated that although certain components of the digital design system 800 are described in the previous examples with regard to particular elements of the environment 1000, various alternative implementations are possible. For instance, in one or more embodiments, the digital design system 800 is implemented on any of the client devices 1006A-1006N. Similarly, in one or more embodiments, the digital design system 800 may be implemented on the one or more servers 1004. Moreover, different components and functions of the digital design system 800 may be implemented separately among client devices 1006A-1006N, the one or more servers 1004, and the network 1008.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates, in block diagram form, an exemplary computing device 1100 that may be configured to perform one or more of the processes described above. One will appreciate that one or more computing devices such as the computing device 1100 may implement the image processing system. As shown by FIG. 11, the computing device can comprise a processor 1102, memory 1104, one or more communication interfaces 1106, a storage device 1108, and one or more I/O devices/interfaces 1110. In certain embodiments, the computing device 1100 can include fewer or more components than those shown in FIG. 11. Components of computing device 1100 shown in FIG. 11 will now be described in additional detail.

In particular embodiments, processor(s) 1102 includes hardware for executing instructions, such as those making up a computer program. As an example, and not by way of limitation, to execute instructions, processor(s) 1102 may retrieve (or fetch) the instructions from an internal register, an internal cache, memory 1104, or a storage device 1108 and decode and execute them. In various embodiments, the processor(s) 1102 may include one or more central processing units (CPUs), graphics processing units (GPUs), field programmable gate arrays (FPGAs), systems on chip (SoC), or other processor(s) or combinations of processors.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1104 may be internal or distributed memory.

The computing device 1100 can further include one or more communication interfaces 1106. A communication interface 1106 can include hardware, software, or both. The communication interface 1106 can provide one or more interfaces for communication (such as, for example, packet-based communication) between the computing device and one or more other computing devices 1100 or one or more networks. As an example and not by way of limitation, communication interface 1106 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can comprise hardware, software, or both that couples components of computing device 1100 to each other.

The computing device 1100 includes a storage device 1108 includes storage for storing data or instructions. As an example, and not by way of limitation, storage device 1108 can comprise a non-transitory storage medium described above. The storage device 1108 may include a hard disk drive (HDD), flash memory, a Universal Serial Bus (USB) drive or a combination these or other storage devices. The computing device 1100 also includes one or more input or output (“I/O”) devices/interfaces 1110, which are provided to allow a user to provide input to (such as user strokes), receive output from, and otherwise transfer data to and from the computing device 1100. These I/O devices/interfaces 1110 may include a mouse, keypad or a keyboard, a touch screen, camera, optical scanner, network interface, modem, other known I/O devices or a combination of such I/O devices/interfaces 1110. The touch screen may be activated with a stylus or a finger.

The I/O devices/interfaces 1110 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1110 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

1. A computer-implemented method comprising:
receiving, by a digital design system, a first input on a graphical user interface, the first input enabling an offset editing mode, the graphical user interface displaying a digital image;
displaying an offset editing tool at a first location on the graphical user interface, the offset editing tool configured to edit portions of the digital image;
receiving a second input starting at a second location and terminating at a third location on the graphical user interface; and
performing an action associated with the offset editing tool at the first location and terminating at a fourth location based on the second input starting at the second location and terminating at the third location, the second location offset from the first location and the third location offset from the fourth location, the action including editing one or more portions of the digital image starting at the first location and terminating at the fourth location to create a modified digital image.

2. The computer-implemented method of claim 1, wherein receiving the first input on the graphical user interface further comprises:
detecting a touch gesture indicating selection of a display element on the graphical user interface.

3. The computer-implemented method of claim 1, wherein performing the action associated with the offset editing tool at the first location and terminating at the fourth location based on the second input starting at the second location and terminating at the third location comprises:
detecting the second input starting at the second location and terminating at the third location;
determining a distance and an angle between the first location corresponding to the offset editing tool and the second location;
determining a direction of the second input between the second location and the third location; and
maintaining the distance and the angle between the offset editing tool and the second input.

4. (canceled)

5. The computer-implemented method of claim 1, further comprising:
receiving a third input at a fifth location on the graphical user interface starting at the fifth location and terminating at a sixth location; and
positioning the offset editing tool at a sixth location on the graphical user interface in response to the third input.

6. The computer-implemented method of claim 1, further comprising:
modifying a display of the offset editing tool to indicate an active state of the offset editing tool in response to the second input.

7. The computer-implemented method of claim 1, further comprising:
receiving an action type selection; and
modifying a display of a cursor shape for a cursor at a center of the offset editing tool based on the action type selection.

8. The computer-implemented method of claim 7, wherein the action type selection includes a draw tool, an erase tool, and a selection tool.

9. The computer-implemented method of claim 1, wherein the first input and the second input are touch gesture-based inputs performed on the graphical user interface.

10. A non-transitory computer-readable storage medium including instructions stored thereon which, when executed by at least one processor, cause the at least one processor to:
receive a first input on a graphical user interface, the first input enabling an offset editing mode, the graphical user interface displaying a digital image;
display an offset editing tool at a first location on the graphical user interface, the offset editing tool configured to edit portions of the digital image;
receive a second input starting at a second location and terminating at a third location on the graphical user interface; and
perform an action associated with the offset editing tool at the first location and terminating at a fourth location based on the second input starting at the second location and terminating at the third location, the second location offset from the first location and the third location offset from the fourth location, the action including editing one or more portions of the digital image starting at the first location and terminating at the fourth location to create a modified digital image

11. The non-transitory computer-readable storage medium of claim 10, wherein receiving the first input on the graphical user interface further comprises:
detecting a touch gesture indicating selection of a display element on the graphical user interface.

12. The non-transitory computer-readable storage medium of claim 10, wherein performing the action associated with the offset editing tool at the first location and terminating at the fourth location based on the second input starting at the second location and terminating at the third location comprises:
detecting the second input starting at the second location and terminating at the third location;
determining a distance and an angle between the first location corresponding to the offset editing tool and the second location;
determining a direction of the second input between the second location and the third location; and
maintaining the distance and the angle between the offset editing tool and the second input.

13. (canceled)

14. The non-transitory computer-readable storage medium of claim 10, further comprising:
receiving a third input at a fifth location on the graphical user interface starting at the fifth location and terminating at a sixth location; and
positioning the offset editing tool at a sixth location on the graphical user interface in response to the third input.

15. The non-transitory computer-readable storage medium of claim 10, further comprising:
modifying a display of the offset editing tool to indicate an active state of the offset editing tool in response to the second input.

16. The non-transitory computer-readable storage medium of claim 10, further comprising:
receiving an action type selection; and
modifying a display of a cursor shape for a cursor at a center of the offset editing tool based on the action type selection.

17. A system, the system comprising:
a computing device including a memory and at least one processor, the computing device implementing a digital design system,
wherein the memory includes instructions stored thereon which, when executed, cause the digital design system to:
receive a first input on a graphical user interface, the first input enabling an offset editing mode, the graphical user interface displaying a digital image;
display an offset editing tool at a first location on the graphical user interface, the offset editing tool configured to edit portions of the digital image;
receive a second input starting at a second location and terminating at a third location on the graphical user interface; and
perform an action associated with the offset editing tool at the first location and terminating at a fourth location based on the second input starting at the second location and terminating at the third location, the second location offset from the first location and the third location offset from the fourth location, the action including editing one or more portions of the digital image starting at the first location and terminating at the fourth location to create a modified digital image

18. The system of claim 17, wherein the instructions to receive the first input on the graphical user interface, when executed, further causes the digital design system to:
detect a touch gesture indicating selection of a display element on the graphical user interface.

19. The system of claim 17, wherein the instructions to the action associated with the offset editing tool at the first location and terminating at the fourth location based on the second input starting at the second location and terminating at the third location, when executed, further causes the digital design system to:
detect the second input starting at the second location and terminating at the third location;
determine a distance and an angle between the first location corresponding to the offset editing tool and the second location;
determine a direction of the second input between the second location and the third location; and
maintain the distance and the angle between the offset editing tool and the second input.

20. (canceled)

21. The method of claim 1, further comprising:
detecting a period of inactivity in response to an absence of a user contact with the graphical user interface greater than a threshold amount of time; and
modifying a display of the offset editing tool in response to detecting the period of inactivity.

22. The method of claim 1, wherein the first input enabling the offset editing mode is a long press touch gesture on a touch screen displaying the graphical user interface.

23. The method of claim 1, wherein the action associated with the offset editing tool is an erase action that erases one or more portions of the digital image starting at the first location and terminating at the fourth location.
